(19) United States
(12) Patent Application Publication
(10) Pub. No.: US 2014/0253966 A1
(43) Pub. Date: Sep. 11, 2014

(54) IMAGE FORMING APPARATUS, CONTROL METHOD THEREFOR, AND STORAGE MEDIUM

(71) Applicant: CANON KABUSHIKI KAISHA, Tokyo (JP)

(72) Inventor: Daisuke ITO, Kawasaki-shi (JP)

(73) Assignee: CANON KABUSHIKI KAISHA, Tokyo (JP)

(21) Appl. No.: 14/203,640

(22) Filed: Mar. 11, 2014

(30) Foreign Application Priority Data
Mar. 11, 2013 (JP) 2013-047956

(51) Int. Cl. H04N 1/00

(52) U.S. Cl. CPC H04N 1/00954
USPC 358/1.15

(57) ABSTRACT

An image forming apparatus which is capable of collectively managing counter information for storing a count value obtained by counting events that have occurred with operation of an application of an external apparatus. The image forming apparatus has a display unit and a storage unit. A registration unit registers an identifier of an application of a server so as to utilize the application. A generation unit generates, when the identifier of the application is registered by the registration unit, in the storage unit, counter information used for storing a count value obtained by counting at least one of the number of printed sheets and the number and read originals that has occurred with operation of the application.

### BACKGROUND OF THE INVENTION

1. Field of the Invention

The present invention relates to an image forming apparatus, a control method therefor, and storage medium.

2. Description of the Related Art

There are image forming apparatuses such as MFP (Multi-Function Peripherals) and LBP (Laser Beam Printer). The image forming apparatuses execute jobs such as copying, scanning, and printing in accordance with operation performed by users.

A counter mechanism disposed in conventional image forming apparatuses performs count-up of the number of times of printing or scanning is performed in response to the job execution, arbitrary count-up responsive to a request from an application, and so forth. MFP charging systems include those which use count data obtained by such count-up.

In many cases, a counter which is generally used by an application is generated when the application is installed in an image forming apparatus because memory resources of the image forming apparatus are not abundant.

Moreover, in recent systems, an application is on a server side, and hence a configuration in which a job is input via a Web service installed and opened in the image forming apparatus has also been prevailing.

This configuration does not involve installation of an application in the image forming apparatus, which prevents a counter for a Web application from being generated.

For this reason, there is a problem that management software based on a counter of the image forming apparatus such as the charging system described above is very complicated in terms of arrangement in a case where target data is distributed among the image forming apparatuses and the servers.

As an approach to solve this problem, customization of information included in a shortcut itself of the Web application is conceivable (see Japanese Laid-Open Patent Publication (Kokai) No. H07-36651, for example).

According to the technique disclosed in Japanese Laid-Open Patent Publication (Kokai) No. H07-36651, data is, however, configured separately from count data in the image forming apparatus although information included in the shortcut can be customized.

This provides no satisfactory means for solving the problem because a problem of an arrangement therefor is made complicated still remains although data can be compiled.

### SUMMARY OF THE INVENTION

The present invention provides an image forming apparatus and a control method therefor, which are capable of collectively managing counter information for storing a count value obtained by counting events that have occurred with operation of an application of an external apparatus, as well as a storage medium.

Accordingly, a first aspect of the present invention provides an image forming apparatus having a display unit and a storage unit, comprising: a registration unit configured to register an identifier of an application of a server so as to utilize the application; and a generation unit configured to, when the identifier of the application is registered by the registration unit, generate, in the storage unit, counter information used for storing a count value obtained by counting at least one of the number of printed sheets and the number of read originals that has occurred with operation of the application.

According to the present invention, it is possible to collectively manage counter information for storing a count value obtained by counting events that have occurred with operation of an application in the external apparatus.

Further features of the present invention will become apparent from the following description of exemplary embodiments with reference to the attached drawings.

### BRIEF DESCRIPTION OF THE DRAWINGS

FIG. 1 is a view schematically showing an arrangement of an image forming system according to an embodiment of the present invention.

FIG. 2 is a view schematically showing a hardware arrangement of an image forming apparatus in FIG. 1.

FIG. 3 is a view schematically showing a software arrangement of the image forming apparatus in FIG. 1.

FIG. 4 is a view showing an exemplary screen displayed on a user interface unit of the image forming apparatus in FIG. 1.

FIG. 5 is a view which is useful in explaining a counter in FIG. 3.

FIG. 6 is a flowchart showing the procedure of a counter generation process carried out by a core in FIG. 2.

FIG. 7 is a flowchart showing the procedure of a URL validation process carried cut by the core FIG. 2.

FIG. 8 is a flowchart showing the procedure of a counter deletion process carried out by the core in FIG. 2.

### DESCRIPTION OF THE EMBODIMENTS

The present invention will now be described in detail with reference to the drawings showing an embodiment thereof.

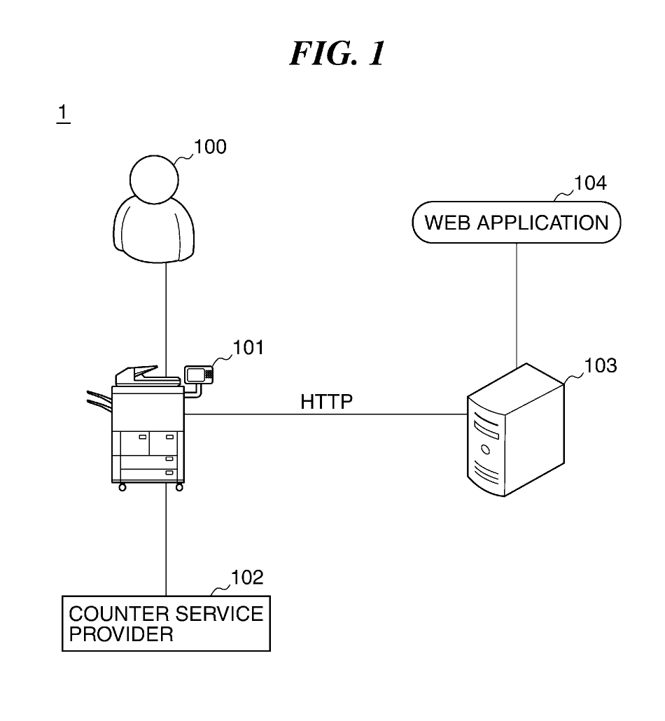

FIG. 1 is a view schematically showing an arrangement of an image forming system 1 according to an embodiment of the present invention.

Referring to FIG. 1, the image forming system 1 is comprised of an image forming apparatus 101 and a Web server 103 (hereinafter referred to as simply “the server”), which is an external apparatus.

The image forming apparatus 101 is equipped with a counter service provider 102, and the server 103 is installed with a Web application 104.

The Web application 104 is capable of performing a counter operation by way of the counter service provider 102 of the image forming apparatus 101 in response to operation performed by a user. The number of image forming apparatuses 101 and the number of servers 103 should not be limited to those shown in FIG. 1.

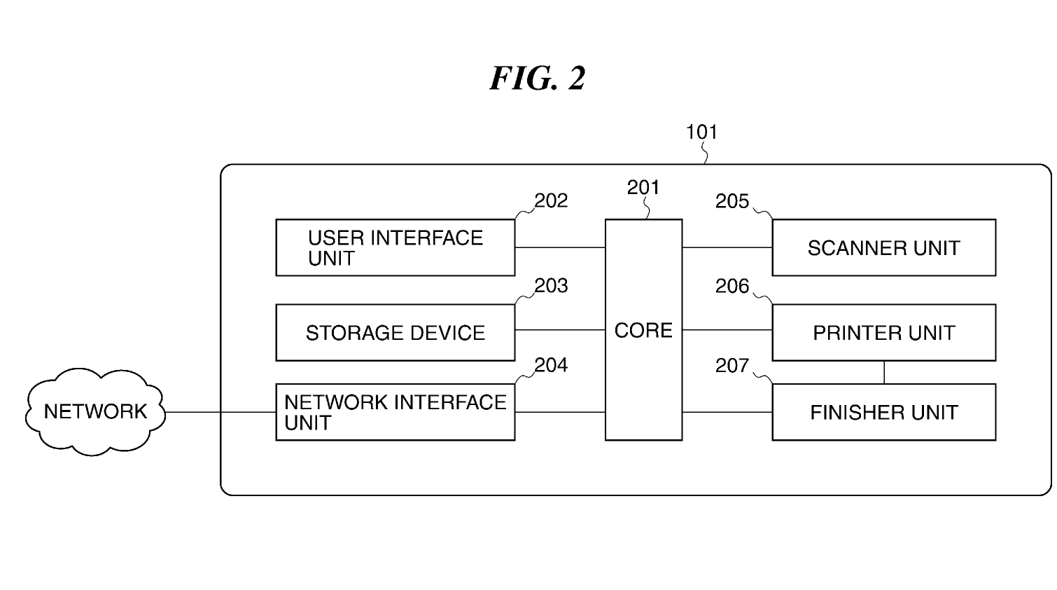

FIG. 2 is a view schematically showing a hardware arrangement of the image forming apparatus 101 appearing in FIG. 1.

Referring to FIG. 2, the image forming system 101 has a user interface unit 202, a storage device 203, a network interface unit 204, a scanner unit 205, a printer unit 206, and a finisher unit 207, which are connected to one another via a core 201.

The core 201, which includes a CPU and others, controls the entire image forming apparatus 101. The user interface unit 202 has a display unit which displays information for a user 100 and receives operations from the user 100.

The device 203, which is a storage unit, stores software and data of the image forming apparatus 101 and stores counter information, described later, as well. The network interface unit 204 is an interface to a network.

The scanner unit 205, the printer unit 206, and the finisher unit 207, which are controlled in conjunction with one another using software of the image forming apparatus 101, realize jobs such as copying, printing, and scanning.

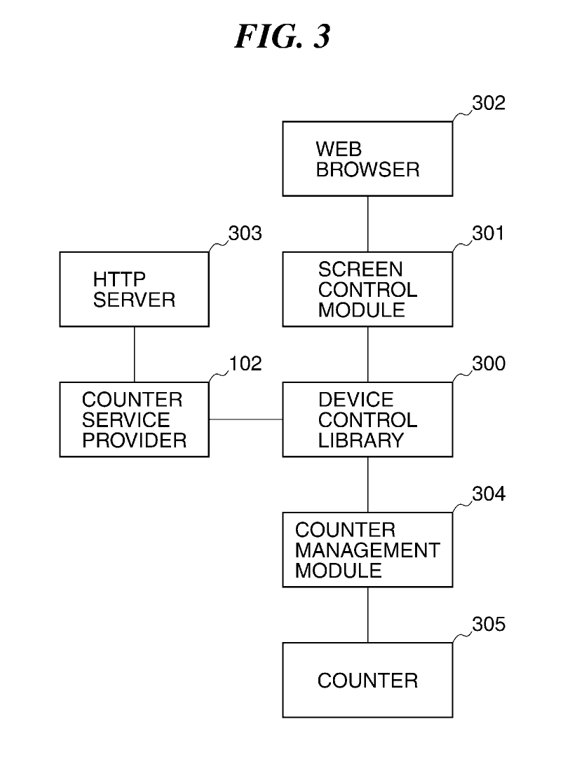

FIG. 3 is a view schematically showing a software arrangement of the image forming apparatus 101 appearing in FIG. 1.

Referring to FIG. 3, a screen control module 301 controls screen display on the use interface unit 202, and more specifically, display application icons or the like for the image forming apparatus 101.

A Web browser 302 controls display of a Web application and creates a shortcut icon for the Web application by cooperating with the screen control module 301.

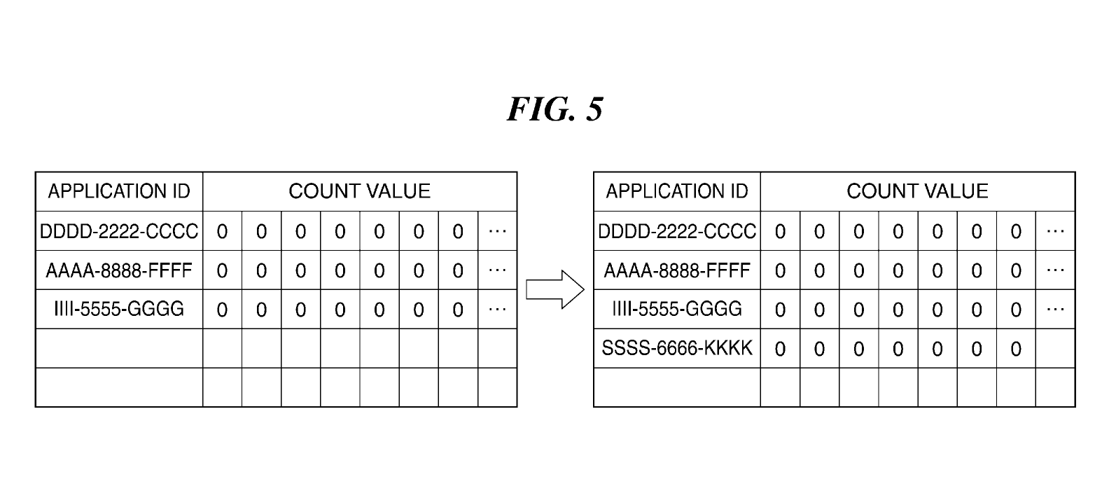

A counter management module 304 carries out data control for a counter 305, which is the counter information mentioned above. The counter service provider 102 is able to register itself on an HTTP server 303. The counter service provider 102 is also able to operate in conjunction with the counter management module 304 via a device control library 300 and operating the counter 305, described later with reference to FIG. 5.

The counter 305 is not only used by an application, but also is capable of counting, when scanning or printing is performed, the number of originals or the number of printed pages by way of the device control library 300.

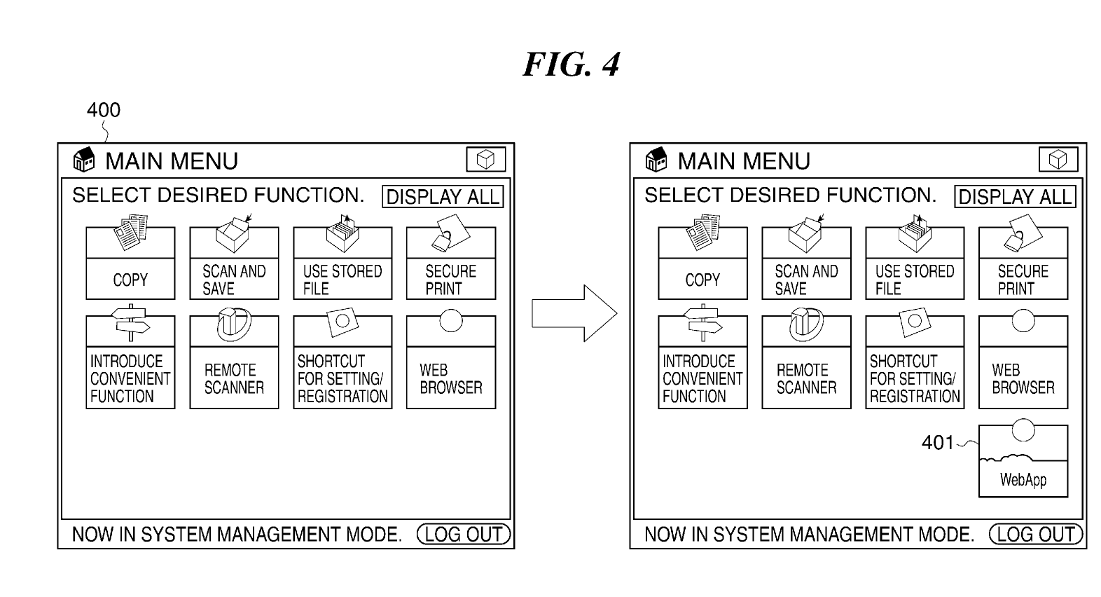

FIG. 4 is a view showing an exemplary screen displayed on the user interface unit 202 of the image forming apparatus 101 in FIG. 1.

Referring to FIG. 4 the user interface unit 202 is capable of displaying icons for applications installed in the image forming apparatus 101 like a screen 400. The user interface unit 202 is also capable of creating a shortcut to a Web application and displaying it like a shortcut icon 401.

This example is based on a local of the image forming apparatus 101, but there may be used a Web application for which the screen 400 itself is on a server side.

FIG. 5 is a view which is useful in explaining the counter 305 in FIG. 3.

Referring to FIG. 5, the counter 305 is comprised of application IDs and count values.

The application IDs are identifiers for identifying applications. The count values represent those obtained by counting events that have occurred with operation of applications. For example, the number of times that printing or scanning is performed using an application identified by an application ID thereof is managed as a count value.

In the present embodiment, as shown in FIG. 5, count values obtained by counting a plurality of different events can be stored, and as a result, counting can be performed with respect to a plurality of events. The plurality of count values can be freely used by applications.

It should be noted that examples of events that have occurred with operation of applications include occurrence of a job and printing on one recording sheets.

A counter provided for each application is newly created when an application is installed in the image forming apparatus 101 or when a shortcut to a Web application is created. In the example shown in FIG. 5, the number of applications has been increased from three to four.

The counter 305 described with reference to FIG. 5 and a counter generation process, described later, make it possible to collectively manage counter information for storing count values obtained by counting events that have occurred with operation of applications of the external apparatus.

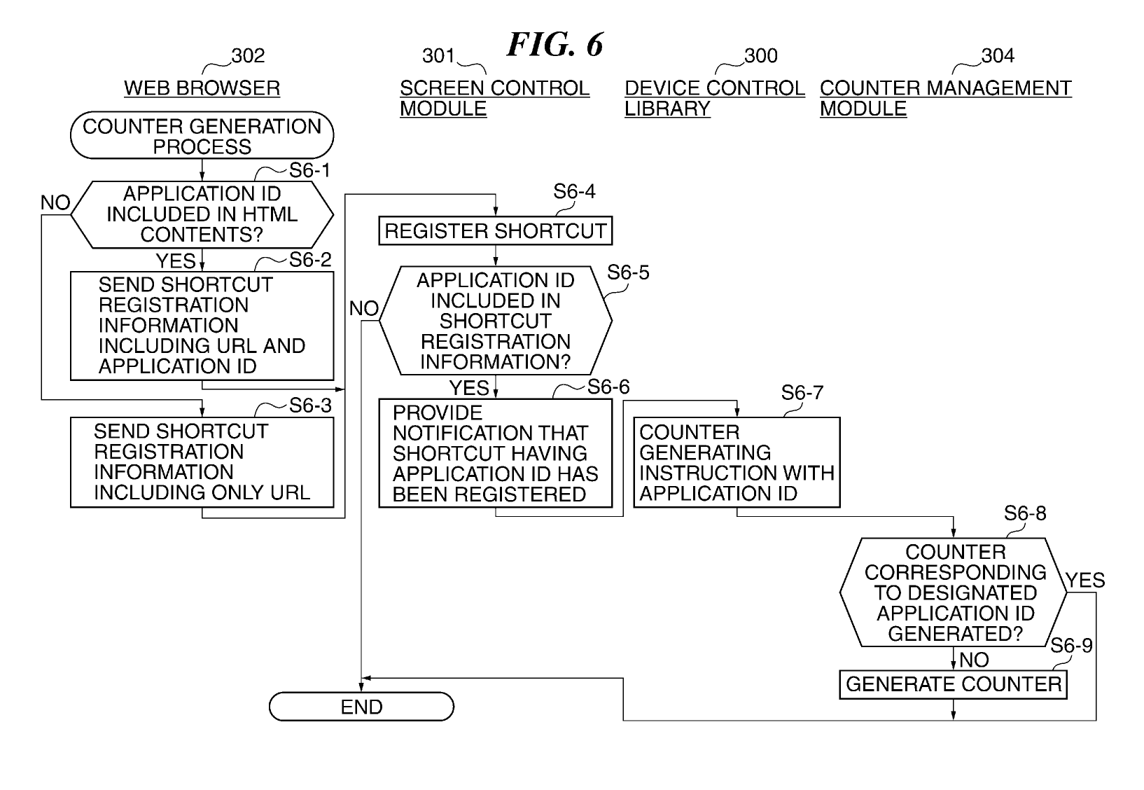

FIG. 6 is a flowchart showing the procedure of the counter generation process carried out by the core 201 in FIG. 2.

The counter generation process in FIG. 6 is started when the Web browser 302 obtains HTML contents from the Web application 104 and registers a shortcut.

Referring to FIG. 6, first, the Web browser 302 determines whether or not an application ID of the Web application 104 is included in the obtained HTML contents (steps S6-1).

As a result of the determination in the step S6-1, when an application ID of the Web application 104 is included in the HTML contents (YES to the step S6-1), the Web browser 302 sends shortcut registration information including a URL, which is for use in accessing the Web Application 104, as well as the application ID to the screen control module 301 (step S6-2), followed by the program proceeding to step S6-4.

As a result of the determination in the step S6-1, when an application ID of the Web application 104 is not included the HTML contents (NO to the step S6-1), the Web browser 302 sends shortcut registration information including a URL of the Web application 104 to the screen control module 301 (step S6-3), followed by the program proceeding to the step S6-4.

In the next step S6-4, the screen control module 301 carries out a shortcut registration process and determines whether or not the application ID is included in the shortcut registration information (step S6-5). The step S6-4 corresponds to a registration unit that registers a shortcut displayed on the user interface unit 202 in order to use an application of the server 103.

As a result of the determination in the step S6-5, when the application ID is not included in the shortcut registration information (NO to the step S6-5), followed by the program being immediately terminated.

On the other hand, a result of the determination in the step S6-5, when the application ID is included in the shortcut registration information (YES to the step S6-5), the screen control module 301 notifies the device control library 300 that a shortcut having the application ID has been registered (step S6-6).

The device control library 300 provides the counter management module 304 with a counter generating instruction as well as information indicative of the application ID (step S6-7).

The counter management module 304 then determines whether or not a counter corresponding to the provided application ID has already been generated (step S6-8).

As a result of the determination in the step S6-8, when a counter corresponding to the provided application ID has already been generated (YES to the system S6-8), the program is immediately terminated.

On the other hand, as a result of the determination in the step S6-8, when a counter corresponding to the provided application ID has not yet been generated (NO to the step S6-8), the counter management module 304 generates a counter (step S6-9), followed by terminating the program. The step S6-9 corresponds to a generation unit generating counter information used for storing a count value which is obtained by counting events that have occurred with operation of an application, in the storage device 203 in association with an application ID.

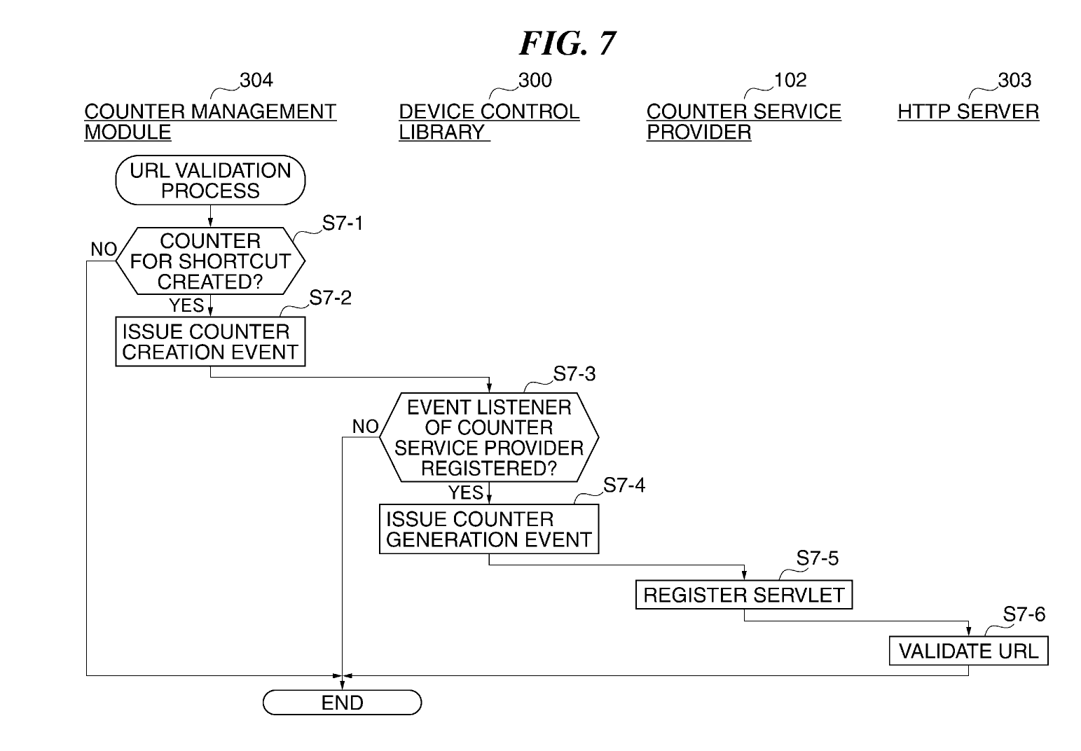

FIG. 7 is a flowchart showing the procedure of a URL validation process carried out by the core 201 appearing in FIG. 2.

The URL validation process in FIG. 7 is started when a counter is generated by the counter generation process in FIG. 6.

Referring to FIG. 7, first, the counter management module 304 determines whether or not a counter for a shortcut to a Web application has been generated (step S7-1), and when a counter for a shortcut to a Web application has not been generated (NO to the step S7-1), the program is immediately terminated.

On the other hand, as a result of the determination in the step S7-1, when a counter for a shortcut to a Web application has been generated (YES to the step S7-1), the counter management module 304 issues a counter generation event in which a counter is generated and notifies the device control library 300 of this event (step S7-2).

The device control library 300 then determines whether or not an event listener of the counter service provider 102 is registered in the device control library 300 itself (step S7-3).

As a result of the determination in the step S7-3, when an event listener of the counter service provider 102 is not registered (NO to the step S703), the program is immediately terminated.

On the other hand, as a result of the determination in the step S7-3, when an event listener of the counter service provider 102 is registered (YES to the step S7 -3), the device control library 300 issues a counter generation event and notifies the counter service provider 102 of this event (step S7-4).

The counter service provider 102 then registers its own Servlet in the HTTP server 303 (step S7-5). The HTTP server 303 validates the registered URL (step S7-6), followed by terminating the present process. The step S7-6 corresponds to a validation unit that validates, when counter information is generated, a service provided by an application.

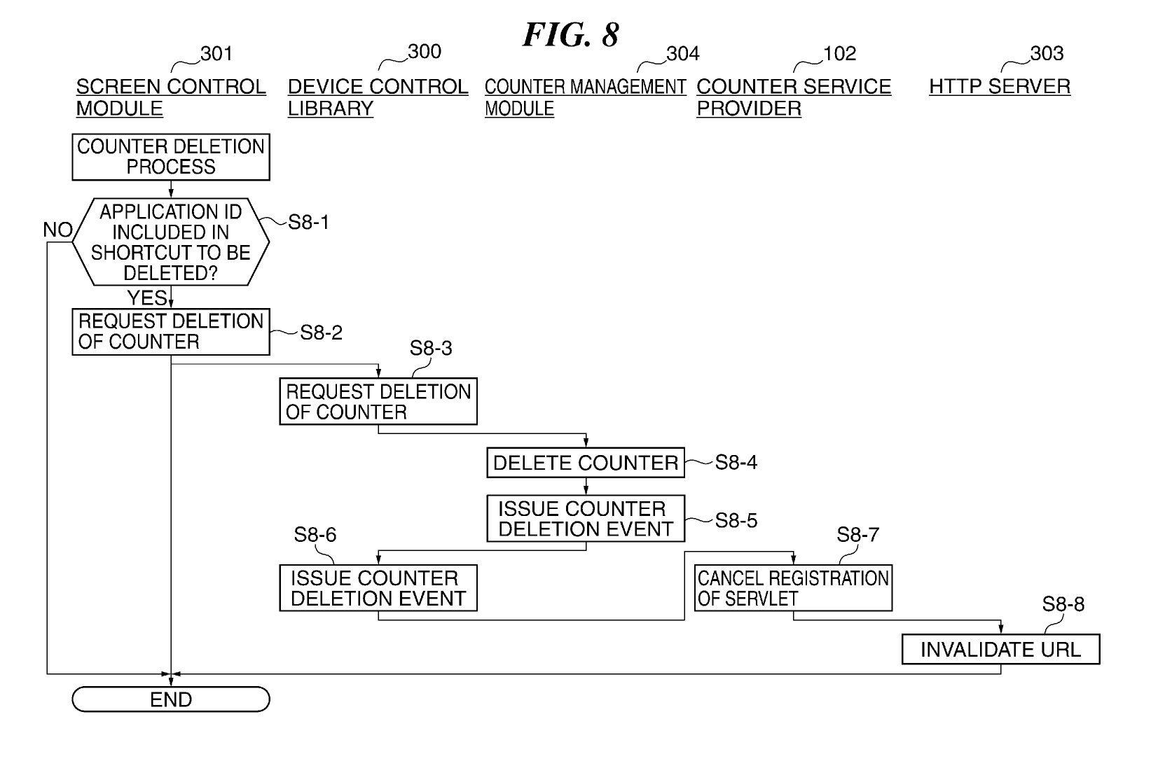

FIG. 8 is a flowchart showing the procedure of a counter deletion process carried out by the core 201 in FIG. 2.

The counter deletion process in FIG. 8 is started when the screen control module 301 deletes the shortcut icon 401.

Referring to FIG. 8, first, the screen control module 301 determines whether or not there is an application ID in information related to the shortcut icon 401 to be deleted (step S8-1).

As a result of the determination in the step S8-1, when there is no application ID in information related to the shortcut on 401 (NO to the step S8-1), the program is immediately terminated.

On the other hand, as a result of the determination in the step S8-1, when there is an application ID in information related the shortcut icon 401 (YES to the step S8-1), the screen control module 301 requests the device control library 300 to delete a counter (step S8-3).

The device control library 300 then requests the counter management module 304 to delete a counter (step S8-3), and the counter management module 304 then deletes the corresponding counter (step S8-4), issues a counter deletion event, and notifies the device control library 300 of this event (step S8-5).

The device control library 300 then issues a counter deletion event and notifies the service counter provider 102 of this event (step S8-6).

The service counter provider 102 cancels registration of its own Servlet (step S8-7), and the HTTP server 303 invalidates the concerned URL (step S8-8), followed by terminating the program. Therefore, in the present embodiment, when the shortcut is deleted, counter information associated with the application ID corresponding to the shortcut is deleted. This increases the amount of free space on the storage device 203 of the image forming apparatus 101, enabling effective use of the storage device 203.

According to the present embodiment, it is possible to compile counters including a counter for a Web application using an arrangement that compiles counters of an image forming apparatus hitherto known, which reduces costs of the system development and may improve the accuracy of analyzing the counter values.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-047956 filed Mar. 11, 2013 which is hereby incorporated by reference herein in its entirety.

What is claimed is:

1. An image forming apparatus having a display unit and a storage unit, comprising:
a registration unit configured to register an identifier of an application of a server so as to utilize the application; and
a generation unit configured to, when the identifier of the application is registered by said registration unit, generate, in the storage unit, counter information used for storing a count value obtained by counting at least one of the number of printed sheets and the number of read originals that has occurred with operation of the application.

2. The image forming apparatus according to claim 1, wherein said registration unit registers a shortcut used for utilizing the application of the server, in association with the identifier of the application.

3. The image forming apparatus according to claim 1, further comprising a validation unit configured to validate a service provided by the application, when the counter information is generated by said generation unit.

4. The image forming apparatus according to claim 1, wherein a count value obtained by counting a plurality of different events can be stored as the counter information.

5. The image forming apparatus according to claim 1, wherein in a case where the identifier of the application is deleted, the counter information associated with the identifier for the application is deleted.

6. The image forming apparatus according to claim 1, wherein said registration unit registers, as a shortcut, a URL for accessing an application of the server using a Web browser.

7. A control method of an image forming apparatus having a display unit and a storage unit, the control method comprising:
a registration step of registering an identifier of an application of a server so as to utilize the application; and
a generation step of, when the identifier of the application is registered at said registration step, generating, in the storage unit, counter information used for storing a count value obtained by counting at least one of the number of printed sheets and the number of read originals that has occurred with operation of the application.

8. The control method for the image forming apparatus according to claim 7, wherein said registration step comprises registering a shortcut used for utilizing the application of the server, in association with the identifier of the application.

9. The control method for the image forming apparatus according to claim 7, further comprising a validation step of validating a service provided by the application, when the counter information is generated by said generation unit.

10. The control method for the image forming apparatus according to claim 7, wherein a count value obtained by counting a plurality of different counts can be stored as the counter information.

11. The control method for the image forming apparatus according to claim 7, wherein in a case where the identifier of the application is deleted, the counter information associated with the identifier for the application corresponding to the shortcut is deleted.

12. The control method for the image forming apparatus according to claim 7, wherein said registration step comprises registering, as a shortcut, a URL for accessing an application of the server using a Web browser.

13. A non-transitory computer-readable storage medium storing a program for causing a computer to execute a control method for an image forming apparatus having a display unit and a storage unit, the control method comprising:
a registration step of registering an identifier of an application of a server so as to utilize the application; and
a generation step of, when the identifier of the application is registered at said registration step, generating, in the storage unit, counter information used for storing a count value obtained by counting at least one of the number of printed sheets and the number of read originals that has occurred with operation of the application.
